(19) United States
(12) Patent Application Publication
(10) Pub. No.: US 2015/0208353 A1
(43) Pub. Date: Jul. 23, 2015

(54) METHOD AND APPARATUS FOR REDUCING POWER CONSUMPTION OF TERMINAL

(71) Applicant: LG ELECTRONICS INC., Seoul (KR)

(72) Inventors: Seungmin JUNG, Seoul (KR); Jongwook LEE, Seoul (KR)

(73) Assignee: LG ELECTRONICS INC., Seoul (KR)

(21) Appl. No.: 14/587,547

(22) Filed: Dec. 31, 2014

(30) Foreign Application Priority Data
Jan. 17, 2014 (KR) 10-2014-0006298
May 7, 2014 (KR) 10-2014-0054285

(51) Int. Cl. H04W 52/02; H04W 4/02

(52) U.S. Cl. CPC H04W 52/0254; H04W 52/0216; H04W 4/026; H04W 88/02

(57) ABSTRACT

A method and apparatus for reducing power consumption of a terminal in a wireless communication system are provided. The method for reducing power consumption of a terminal in a wireless communication system includes measuring movement information of the terminal, calculating a location change value of the terminal based on the movement information, determining whether there is movement of the terminal based on the location change value, and determining whether to measure a neighbor cell in a power saving duration of a discontinuous reception duration based on the determination of whether there is movement of the terminal, wherein the power saving duration is duration that the terminal does not transceive data, and wherein the movement information includes at least one of velocity information, acceleration information, location information, direction information or angle information of the terminal.

### CROSS-REFERENCE TO RELATED APPLICATION

Pursuant to 35 U.S.C. §119(a), this application claims the benefit of earlier filing date and right of priority to Korean Patent Application Nos. 10-2014-0006298, filed on Jan. 17, 2014, and 10-2014-0054285, filed on May 7, 2014, the contents of which are all hereby incorporated by reference herein in their entirety.

### BACKGROUND OF THE INVENTION

1. Field of the Invention

The present invention relates to evolved universal mobile telecommunications system (E-UMTS) in wireless communication and, more particularly, to a method for reducing power consumption of a terminal by optimizing measurement of a neighbor cell of the terminal.

2. Related Art

In general, universal mobile telecommunications system (UMTS) refers to cover WCDMA R99 stipulated by 3GPP to HSDPA, HSUPA, and even HSPA+. Namely, 3^{rd}-generation technologies based on CDMA techniques are called UMTS.

An E-UMTS system is a system which has evolved from the existing UMTS system and which is currently under standardization in 3GPP. Such an E-UMTS system may also be called a long term evolution (LTE) system.

An E-UMTS network may be classified as an E-UTRAN and a core network (CN). The E-UTRAN includes a terminal, a base station (BS), an access gateway (AG) connected to an external network. The AG may be divided into part that handles processing of user traffic and part that handles processing of control traffic. One or more cells may exist in a single BS.

In general, in an E-UMTS system, a terminal is served by a single serving cell. However, in a case in which a signal from a serving cell is weaken or quality of service (QoS) is degraded, the terminal may need to perform handover to a different neighbor cell so as to be continuously stably served.

Thus, even though the terminal is served by the serving cell, the terminal should continuously measure signal strength of the serving cell and signal strength of a different neighbor cell in order to perform handover to the neighbor cell providing a better service in case a signal from the serving cell weakens.

However, such a continuous measurement of a neighbor cell may increase power consumption of the terminal, and in a case in which a terminal is continuously served in a place without movement, the terminal may be continuously stably served by a serving cell, and thus, the terminal may not need to measure a neighbor cell. Thus, measurement of a neighbor cell even in this case may increase power consumption of the terminal.

### SUMMARY OF THE INVENTION

An aspect of the present invention provides a method and apparatus for reducing power consumption of a terminal by not measuring a neighbor cell when it is determined that a state of the terminal is not changed, namely, when it is determined that the terminal will not perform handover or cell reselection.

Another aspect of the present invention provides a method and apparatus for reducing power consumption of a terminal in a wireless communication system.

Another aspect of the present invention provides a method and apparatus for reducing power consumption of a terminal by determining whether to measure a neighbor cell in a wireless communication system.

Another aspect of the present invention provides a method and apparatus for reducing power consumption of a terminal by determining whether to measure a neighbor cell by measuring movement of the terminal by a sensor of the terminal in a wireless communication system.

Another aspect of the present invention provides a method and apparatus for reducing power consumption of a terminal by not measuring a neighbor cell when a location of the terminal has not been changed in a wireless communication system.

Another aspect of the present invention provides a method and apparatus for reducing power consumption of a terminal by determining whether to measure a neighbor cell by measuring acceleration of the terminal in a wireless communication system.

In an aspect, a method for reducing power consumption of a terminal in a wireless communication system, may include: measuring movement information of the terminal; calculating a location change value of the terminal based on the movement information; determining whether there is movement of the terminal based on the location change value; and determining whether to measure a neighbor cell in a power saving duration of a discontinuous reception duration based on the determination of whether there is movement of the terminal, wherein the power saving duration is a duration in which the terminal does not transceive data.

The step of determining whether to measure of the neighbor cell may be characterized that the terminal does not measure the neighbor cell when it is determined that there is no movement of the terminal.

The step of determining measurement of a neighbor may further include measuring the neighbor cell, when it is determined that there is movement of the terminal.

The method may further include: changing a state of the terminal to RRC (Radio Resource Control) connection state; and receiving a message including neighbor cell list information from a base station (BS) of a serving cell, wherein the step of measuring the neighbor cell may include: detecting the neighbor cell using the received neighbor cell list information; receiving a control signal from the detected neighbor cell; and measuring the neighbor cell based on the received control signal.

The movement information of the terminal may include at least one of velocity information, acceleration information, and location information of the terminal.

In another aspect, a terminal may include: a sensing unit configured to measure movement information of the terminal; a modem configured to calculate a location change value of the terminal based on the measured movement information of the terminal, and determine whether there is movement of the terminal based on the calculated location change value, and determine whether to measure a neighbor cell in a power saving duration of a discontinuous reception duration based on the determination of whether there is movement of the terminal; and a processor configured to receive information related to movement of the terminal from the sensing unit and provide the received information to the modem, wherein the power saving duration is a duration in which the terminal does not transceive data.

The modem may not measure the neighbor cell, when it is determined that there is no movement of the terminal.

The modem may measure the neighbor cell, when it is determined that there is movement of the terminal.

The modem may further include: a communication unit configured to receive a message including a neighbor cell list from a base station (BS) of a serving cell and receive a control signal from a detected neighbor cell; a cell detecting unit configured to detect the neighbor cell using the neighbor cell list; and a cell measurement unit configured to measure the neighbor cell based on the received control signal.

The movement information of the terminal may include at least one of the velocity information, acceleration information, location information of the terminal.

The sensing unit may directly transmit information related to movement of the terminal, to the modem.

The sensing unit may be included in the modem.

In another aspect, a terminal may include: a sensing unit configured to measure movement information of the terminal;

a modem configured to calculate a location change value of the terminal based on the measured movement information, and determine whether there is movement of the terminal based on the calculated location change value and determine whether to measure a neighbor cell in a power saving duration of a discontinuous reception duration based on the determination of whether there is movement of the terminal; and a low power micro-control unit (MCU) configured to receive the movement information from the sensor and deliver the received movement information to the modem, wherein the power saving duration is a duration in which the terminal does not transceive data.

According to an embodiment of the present invention, power consumption of a terminal can be reduced in a wireless communication system.

According to an embodiment of the present invention, since a neighbor cell is not measured, power consumption of a terminal can be reduced in a wireless communication system.

According to an embodiment of the present invention, since whether to measure a neighbor cell is determined based on a movement of a terminal measured by a sensing unit, power consumption of the terminal can be reduced in a wireless communication system.

According to an embodiment of the present invention, since a location change calculated by a sensing unit is directly transmitted to a modem, power consumption of a terminal can be reduced in a wireless communication system.

According to an embodiment of the present invention, since a sensing unit belongs to a modem unit, power consumption of a terminal can be reduced in a wireless communication system.

### BRIEF DESCRIPTION OF THE DRAWINGS

FIG. 1 illustrates a cellular system in a wireless communication system to which the present invention is applied.

FIGS. 2 and 3 illustrate internal structures of a terminal to which the present invention is applied, in which FIG. 2 illustrates an overall internal structure of a terminal to which the present invention is applied and FIG. 3 illustrates a structure of a modem of the terminal to which the present invention is applied.

FIG. 4 illustrates an architecture of a radio access protocol in a communication system to which the present invention is applied.

FIG. 5 illustrates a protocol stack of a control plane with respect to a network between a terminal and an E-UTRAN in an E-UMTS or LTE network to which the present invention is applied.

FIG. 6 illustrates an operation of a terminal in a discontinuous reception (DRX) duration to which the present invention is applied.

FIGS. 7 through 10 illustrate a first embodiment to which the present invention is applied, in which FIG. 7 is an overall schematic view illustrating determining whether to measure a neighbor cell based on a movement of a terminal in a cellular system to which the present invention is applied, FIG. 8 is a flow chart illustrating determining whether to measure a neighbor cell based on a movement of a terminal, FIG. 9 is a specific flow chart illustrating determining whether to measure a neighbor cell based on a change in a location of a terminal, and FIG. 10 is a flow chart illustrating a process of measuring a neighbor cell by a terminal.

FIG. 11 illustrates a structure in which information of a sensor is transmitted to a modem according to a second embodiment to which the present invention is applied.

FIGS. 12a through 12c illustrate a third embodiment to which the present invention is applied, in which FIG. 12a illustrates a structure in which a sensor and a modem are directly connected, FIG. 12b illustrates a structure in which a sensor is included in a modem, and FIG. 12c illustrates a structure in which a sensor and a modem are connected by a low power micro-control unit (MCU).

### DESCRIPTION OF EXEMPLARY EMBODIMENTS

The aforementioned objects, features and advantages of the present invention will become more apparent through the following detailed description with respect to the accompanying drawings. Hereinafter, the embodiments of the present invention will be described with reference to the accompanying drawings, in which like numbers refer to like elements throughout the specification. In describing the present invention, a detailed description of known techniques associated with the present invention unnecessarily obscure the gist of the present invention, it is determined that the detailed description thereof will be omitted.

Hereinafter, a terminal related to the present invention will be described in detail with reference to the accompanying drawings. In the following description, usage of suffixes such as ‘module’, ‘part’ or ‘unit’ used for referring to elements is given merely to facilitate explanation of the present invention, without having any significant meaning by itself.

An electronic device described in this disclosure may include a cellular phone, a smartphone, a notebook computer, a laptop computer, a digital broadcasting terminal, a personal digital assistant (PDA), a portable multimedia player (PMP), a navigation device, and the like.

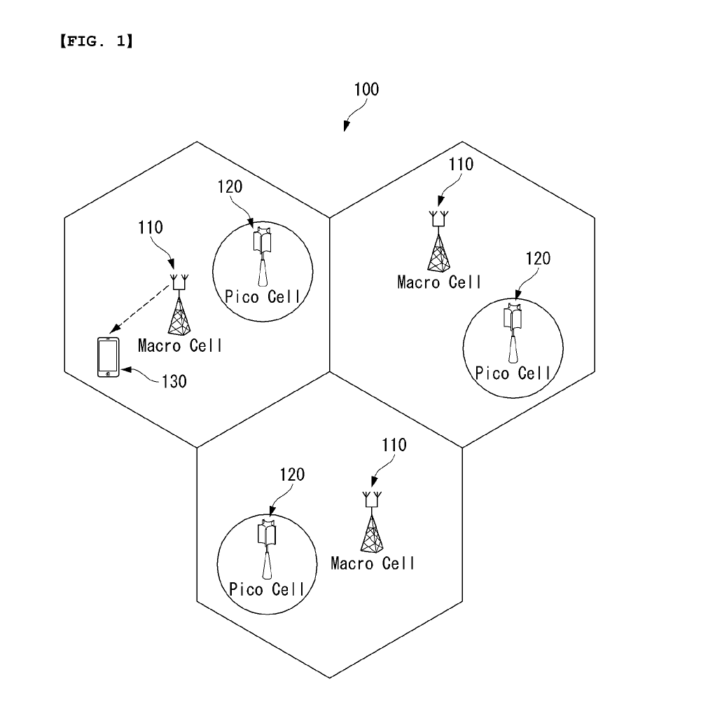

FIG. 1 illustrates a cellular system in a wireless communication system to which the present invention is applied.

Referring to FIG. 1, an example of a disposition structure of a macro cell and a pico cell in a cellular system is illustrated 100.

An existing network disposition method assumes the form of a typical macro cell-centered homogeneous network. However, a disposition of a homogeneous network form is very complicated, and repetitive and increases in shadow areas in the downtown. As a solution to the problem, a heterogeneous network 100 has been discussed.

In general, a heterogeneous network includes a macro cell 110, a pico cell 120, a femto cell, and the like, and FIG. 1 illustrates a heterogeneous network including the macro cell 110 and the pico cell 120. In the heterogeneous network, a base station (BS) of the macro cell 110 transmits a signal with high transmission power ranging from about 5 W to 40 W, and a BS of the pico cell 120 transmits a signal with low transmission power ranging from about 100 mW to 2 W.

In the heterogeneous network, with the pico cell 120 introduced thereto, a cell capacity improvement effect increases when a large amount of terminals receive data from the pico cell 120. Thus, there is a need to induce the terminals 130 to access the pico cell 120, rather than the macro cell 110. To this end, an extended region of the pico cell 120 defined to allow a terminal to access a BS of the pico cell 120 even when receive signal strength of a signal of the macro cell 110 is greater than receive signal strength of a signal of the pico cell 120 exists.

In such a cellular system, the terminal 130 is served by a serving cell 110, and in a case in which signal strength served by the serving cell 110 weakens or when the terminal 130 moves to a region of a different cell, the terminal 130 performs handover to a different neighbor cell so as to be continuously stably served.

Also, in a case in which the terminal 130 is not connected to a cell, namely, in a case in which power of the terminal 130, which has been in an OFF state, is turned on or in a case in which a the terminal 130 to the serving cell 110 is disconnected, the terminal 130 may be connected to a cell through a cell selection or cell reselection process so as to be served.

In order for the terminal 130 to perform handover to a different cell or, perform cell selection or cell reselection, signal strength and a location of the neighbor cell, the number of other served terminals, and the like, need to be measured.

Types of neighbor cells may include an intra-frequency cell, an inter-frequency cell, and an inter-RAT (radio access technology) cell. The intra-frequency cell is a cell having a center frequency and an RAT identical to those of a cell that the terminal is in use, and the inter-frequency cell is a cell having an RAT identical to an RAT of a cell that the terminal is in use and a different center frequency.

The inter-RAT cell is a cell (e.g., GSM, WCDMA) using an RAT different from an RAT that the terminal is in use.

In an LTE system, signal measurement values include reference signal received power (RSRP), reference signal received quality (RARQ), received signal strength indicator (RSSI), and the like.

In order for the terminal 130 to perform cell selection or cell reselection even in an RRC-idle mode as well as in an RRC-connected mode, the terminal 130 should periodically measure signals from the neighbor cells. However, in a case in which the terminal 130 stays in a location, without a movement, there is no possibility of performing handover, and in the case of cell selection or cell reselection, there is no need to measure a neighbor cell. Thus, periodically detecting and measuring neighbor cells may increase power consumption of the terminal 130.

Thus, an embodiment of the present disclosure proposes a method for reducing power consumption of the terminal 130 by not detecting and measuring a neighbor cell when the terminal 130 does not move.

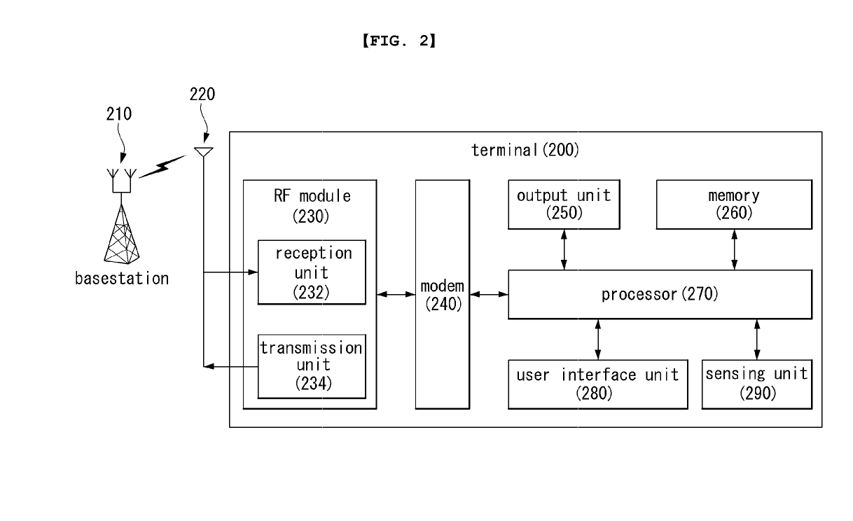

FIG. 2 illustrates an overall internal structure of a terminal to which the present invention is applied. Referring to FIG. 2, a terminal 200 may include a transmission/reception antenna 220, an RF module 230, a modem 240, an output unit 250, a memory 260, a processor 270, a user interface unit 280, a sensor 290, and the like.

The components illustrated in FIG. 2 are not essential and the terminal may be implemented with greater or fewer components.

Hereinafter, the components will be described.

In FIG. 2, it is illustrated that the terminal 200 includes a single transmission/reception antenna 220, but the terminal may also include a plurality of antennas. Thus, the terminal 200 according to an embodiment of the present invention may support a multiple input multiple output (MIMO) system.

The transmission/reception antenna 220 may serve to receive a signal transmitted by a different terminal or a neighbor cell or transmit a signal to the different terminal or the adjacent cell. Quality of service (QoS), strength, and the like, of the neighbor cell may be known by measuring RSRP, RSRQ, and/or RSSI of the signal received from the neighbor cell, among the signals. Based on the result of the measured RSRP, RSRQ, and/or RSSI, the terminal 200 may select the neighbor cell and perform handover, cell selection, or cell reselection.

The RF module 230 may transmit or receive a radio signal to or from the neighbor cell or the different terminal, and in order to perform transmission and reception, the RF module 230 may include a reception unit 232 and a transmission unit 234.

The reception unit 232 receives a signal transmitted from the neighbor cell or the different terminal. Here, the received signal may include a synchronization signal, an interference signal, or a GPS signal for calculating a change in a location of the terminal transmitted from a different neighbor cell in order for the terminal 200 to perform handover, cell selection or cell reselection.

The signal received from the neighbor cell may be used for the terminal 200 to measure the neighbor cell. Namely, the terminal 200 may determine whether to be connected to the neighbor cell by measuring the RSRP, RSRQ, and/or RSSI of the signal from the neighbor cell received through the reception unit 232.

The transmission unit 234 may transmit a signal generated by the terminal 200 to the BS 210 or a different terminal.

The modem 240 may encode, modulate, demodulate, and decode data transmitted or received through the RF module 230. Also, the modem 240 may calculate a change in a location of the terminal 200 and determine a movement using a signal transmitted through the sensor 290 to detect and measure a neighbor cell.

The output unit 250 serves to generate an output related to a sense of sight, a sense of hearing, a sense of touch, and the like, and may include a display unit (not shown), an audio output module (not shown), and the like.

The display unit (not shown) displays information processed in the terminal 200. For example, when the terminal 200 is in a call mode, the display unit (not shown) displays a user interface (UI) or a graphic user interface (GUI) related to a call. When the terminal 200 is in a video call mode or an image capture mode, the display unit (not shown) displays a captured or/and a received image, or a UI or a GUI.

The display unit (not shown) may include at least one of a liquid crystal display (LCD), a thin film transistor-LCD (TFT-LCD), an organic light emitting diode (OLED) display, a flexible display, or a three-dimensional (3D) display.

Some of them may be configured to be transparent or light-transmissive to allow viewing of the exterior, which may be called transparent displays. A typical transparent display may be, for example, a transparent organic light emitting diode (TOLED) display, or the like. A rear structure of the display unit (not shown) may also be configured to be light-transmissive. Through such configuration, the user can view an object positioned at the rear side of the terminal body through the region occupied by the display unit (not shown) of the terminal body.

The audio output module (not shown) may output audio data received from the RF module 230 or stored in the memory 260 in a call signal reception mode, a call mode, a record mode, a voice recognition mode, a broadcast reception mode, and the like. Also, the audio output module (not shown) may output an audio signal related to a function executed in the terminal 200 (e.g., a call signal reception sound, a message reception sound, etc.). The audio output module (not shown) may include a receiver, a speaker, a buzzer, and the like.

The memory 260 is a storage medium for storing various information of the terminal 200 and is connected with the processor 270 to temporarily store a program, application for operation of the processor 270, and input/output data.

The memory 260 may include at least one type of storage medium including a flash memory type, a hard disk type, a multimedia card micro type, a card-type memory (e.g., SD or XD memory, etc), a random access memory (RAM), a static random access memory (SRAM), a read-only memory (ROM), an electrically erasable programmable read-only memory (EEPROM), a programmable read-only memory (PROM), a magnetic memory, a magnetic disk, or an optical disk. Also, the terminal 200 may operate in relation to a web storage that performs a storage function of the memory 260 over the Internet.

The processor 270 instructs and manages all the operations of the terminal 200, and interworks with each device. For example, when the processor 270 receives a movement signal of the terminal measured by the sensor 290, the processor 270 may transmit the movement signal to the modem 240. Through the transmitted movement signal, the modem 240 may calculate a change in a location of the terminal 200 and determine whether to measure the neighbor cell. The movement signal may be comprehensive information regarding states of the terminal, including acceleration information, velocity information, location information, direction information, and the like.

The processor 270 may also be called a controller, a micro-controller, a micro-processor, and the like, and may be implemented by hardware, firmware, software, or any of combinations thereof.

The user interface unit 280 may receive various command signals from a user of the terminal and transmit the same to the processor 270.

The sensor 290 may sense the current state of the terminal 200 such as an opening/closing state of the terminal 200, a location of the terminal 200, whether a user is in contact with the terminal 200, a direction of the terminal 200, acceleration/deceleration of the terminal 200, and the like, and generate a sensing signal for controlling an operation of the terminal 200.

For example, in a case in which the terminal 200 is moving, the sensor 290 may sense a movement velocity, acceleration, and a direction of the terminal 200, and generate a signal including relevant information. Also, the sensor 290 may handle a sensing function related to whether a power is supplied from a power supply unit, whether an external device is coupled to an interface unit, and the like.

Meanwhile, the sensor 290 may be an accelerometer or a position sensor depending on a type of sensed information.

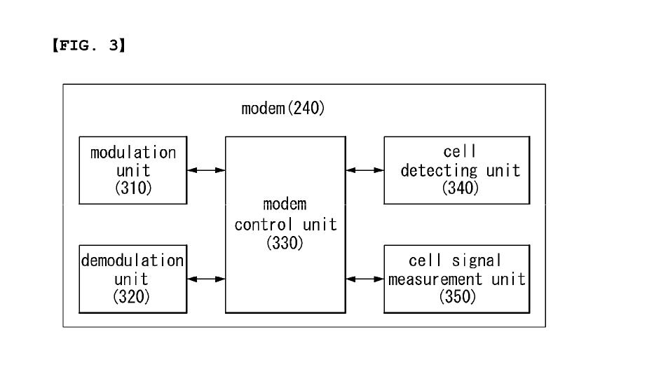

FIG. 3 illustrates a structure of the modem 240 of the terminal to which the present invention is applied. Referring to FIG. 3, the modem 240 may include a modulation unit 310, a demodulation unit 320, a modem control unit 330, a cell detecting unit 340, a cell signal measurement unit 360, and the like.

The components illustrated in FIG. 3 are not essential and the modem 240 may be implemented with greater or fewer components.

Hereinafter, the components will be described.

The modulation unit 310 may modulate data to be transmitted by the terminal according to a preset modulation scheme and deliver the same to the transmission unit. The demodulation unit 320 decodes a signal received by the terminal and delivers the same to the processor.

The modem control unit 330 may instruct and manage all the operations of the modem 240. For example, the modem control unit 330 may determine whether the terminal is currently moving based on a change in a location of the terminal transmitted from the sensor. Also, the modem control unit 330 may instruct the cell detecting unit 340 and the cell signal measurement unit 350 to measure a neighbor cell based on whether the terminal is moving.

When a signal regarding a detection of a neighbor cell is received from the modem control unit 330, the cell detecting unit 340 may detect a neighbor cell of the terminal using a neighbor cell list received from the serving cell.

When an instruction for measuring a signal of a neighbor cell is received from the modem control unit 330, the cell signal measurement unit 350 may measure a signal received from the neighbor cell and measure RSRP, RSRQ, an RSSI, and the like.

The terminal may select a neighbor cell by which the terminal may be effectively served, through the measured value.

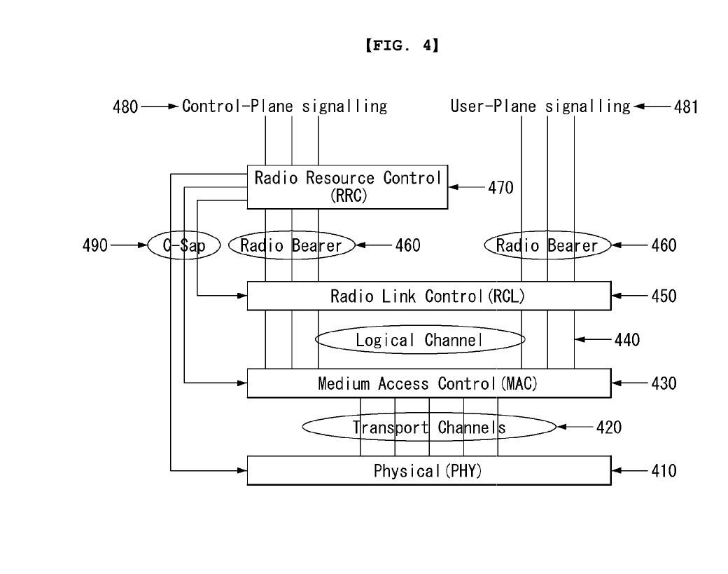

FIG. 4 illustrates an architecture of a radio access protocol in a communication system to which the present invention is applied.

Referring to FIG. 4, a radio access protocol may be divided into two regions of a user plane 481 and a control plane 480 according to types of transmitted data. Also, the hierarchical architecture may include a physical layer 410 corresponding to a first layer, a MAC layer 430 that belongs to a second layer, an RLC layer 450, and an RRC layer 470 that belongs to a third layer. The layers may be connected via a radio bearer 460, a logical channel 440, and a transport channel 420.

In detail, the physical layer 410 may perform transmission of data through a wireless channel between a terminal and a BS, coding, physical layer hybrid automatic repeat request (HARQ) processing, modulation, multi-antenna processing, mapping a signal to an appropriate physical time-frequency resource, mapping a transport channel to a physical channel, and the like. The physical layer 410 may be connected to the MAC layer 430 via the transport channel 420.

The MAC layer 430 may select an appropriate transport channel for transmission of data that handles multiplexing of the logical channel 440 and mapping between the logical channel and the transport channel, and process a medium access control (MAC) service data unit (SDU) delivered from a upper layer to configure a MAC packet data unit (PDU). Also, the MAC layer 430 may perform retransmission of HARQ, uplink and downlink scheduling, and when carrier aggregation is used, data multiplexing and the like. The MAC layer 430 may be connected to the RLC layer 450 via the logical channel 440 and may be connected to the physical layer 410 via the transport channel 420.

The RLC layer 450 is positioned to be upper than the MAC layer 430 and guarantee reliable transmission of data. A transmission side RLC layer may execute segmentation and concatenation functions of an RLC SDU delivered from a higher layer to configure data having an appropriate size for wireless transmission.

A reception side RLC layer may support reassembly function of data to recover the original RLC SDU from the received RLC PDUs. RLC entity included in the RLC layer may operate in three modes: a transparent mode (TM), an unacknowledged mode (UM), and an acknowledged mode (AM).

In order for the terminal to exchange information with the BS, a wireless channel should be set. This is managed by the radio resource control (RRC) layer 470. The RRC layer 470 may provide control functions related to configuration, modification, and release of radio resources. To this end, the RRC layer 470 provides a passage for directly exchanging control information with a lower layer, which is called a control SAP (C-Sap) 490.

RRC procedures for exchanging control information are defined between the RRC layer 470 of the terminal and the RRC layer 470 of the BS. Most RRC procedures may be used for the purpose of controlling functions of the terminal.

The RRC layer 470 of the terminal may be in two states: an RRC_Connected state (or RRC_Connected mode) and an RRC_Idle state (or RRC_Idle mode). In the RRC_Connected state, RRC context may be formed. Namely, parameters required for the terminal and the BS to communicate are known to both of the terminal and the BS. A cell to which the terminal belongs is known, and an identity of the terminal, namely, a cell radio-network temporary identifier (C-RNTI) used for signaling between the terminal and the BS may be set.

the terminal and the BS transmit and receive data in the RRC Connected state, and in the RRC_Idle state, the RRC context does not exist in the BS and the terminal does not belong to any particular cell. In this state, data transmission is not made for most period of time in the terminal in order to reduce battery consumption.

Uplink synchronization is not maintained, and thus, the only available uplink transmission is a random access performed to move to the RRC_Connected state.

In the present invention, by determining whether to measure a neighbor cell for handover, cell selection, or cell reselection depending on a movement of the terminal in the RRC_Connected state or the RRC_Idle state, power consumption of the terminal may be reduced.

A data transmission service may be provided between the terminal and the BS via a radio bearer 460. The radio bearer 460 may be a transmission service of data provided to a upper layer by the second layer. Characteristics of the radio bearer 460 may be determined by characteristics of a lower protocol layer, the transport channel 420, the physical channel, and the like.

In order to differentiate from a radio bearer 460 of the user plane 481 that transmits user data, a radio bearer 460 for transmission of data of the control plane 480 may be called a signaling radio bearer (SRB).

The radio bearer 460 may provide a bi-directional or uni-directional service for a upper layer. Directionality of a provided service may be determined by an RLC entity in use.

In the RRC_Idle state, when RRC connection of the terminal to the BS is successful, a non-access stratum (NAS) layer of the terminal may be notified by a lower layer that the user plane radio bearer has been set.

The user plane 481 may be a region in which traffic information of a speaker such as a voice, an IP packet, and the like, is transmitted, and the control plane 480 may be a region in which control information such as maintaining, managing an interface of a network or a communication link, and the like, is transmitted.

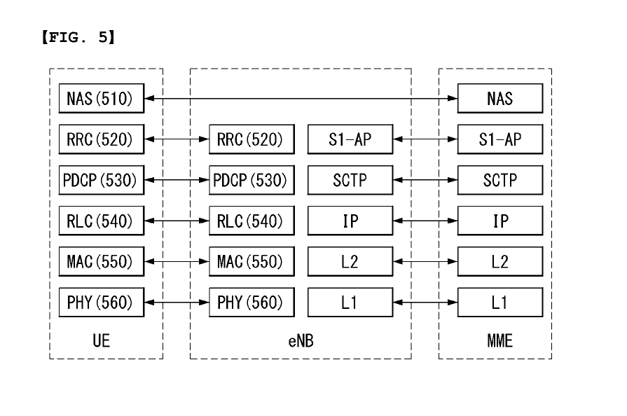

FIG. 5 illustrates a protocol stack of a control plane with respect to a network between a terminal and an E-UTRAN in an E-UMTS or LTE network to which the present invention is applied.

Referring to FIG. 5, an E-UMTS network may be classified as an E-UTRAN and a core network (CN). The E-UTRAN includes a terminal, a BS, and an access gateway (AG) connected to an external network. The AG may be divided into a part that handles processing of user traffic and a part that handles control traffic. One or more cells may exist in a single BS.

Layers of a radio interface protocol between the terminal and the BS can be classified into a first layer (L1), a second layer (L2), and a third layer (L3), and here, a physical (PHY) layer belonging to the first layer provides an information transfer service by using a physical channel and is connected to the higher MAC layer 550, an L2 layer, via a transport channel.

The MAC layer 550, a second layer, may provide a service for the RLC layer 540, a upper layer, via a logical channel.

An RRC layer 520 positioned in the third layer serves to control radio resource between the terminal and the BS. This layer is defined only in the control plane and serves to control the logical channel, the transport channel, and the physical channel in association with configuration, reconfiguration and release of radio bearers (RBs). To this end, the RRC layers 520 may exchange an RRC message between the terminal and the BS.

In the present invention, the BS may provide measurement configuration information regarding which cell is to be measured or how a cell is to be reported, to the terminal through the RRC message. The measurement configuration information may include a measurement type, a measurement object, and the like.

In the RRC_Connected mode or the RRC_Idle mode, the terminal may measure the neighbor cell. In the RRC_Connected mode, the terminal is in an active state, so the terminal may immediately measure the neighbor cell. However, in the RRC_Idle mode, the terminal is in an inactive state, and thus, in order to measure the neighbor cell, the terminal needs to be activated.

Thus, in order to measure the neighbor cell in the RRC_Idle mode, the terminal consumes a large amount of power, compared with the RRC_Connected mode. Thus, periodical measurement of the neighbor cell even in the case in which there is no need to periodically measure the neighbor cell for handover, cell selection, or cell reselection in the RRC_Idle mode may increase power consumption of the terminal.

The present invention proposes a method for solving the foregoing problem by determining whether to measure a neighbor cell depending on whether the terminal moves and measuring a neighbor cell.

When the measurement result, namely, the result value regarding the measurement configuration information, satisfies a measurement report condition, the terminal may report to the BS through the RRC message.

The NAS layer 510 positioned upper than the RRC layer may execute functions such as session management, mobility management, and the like.

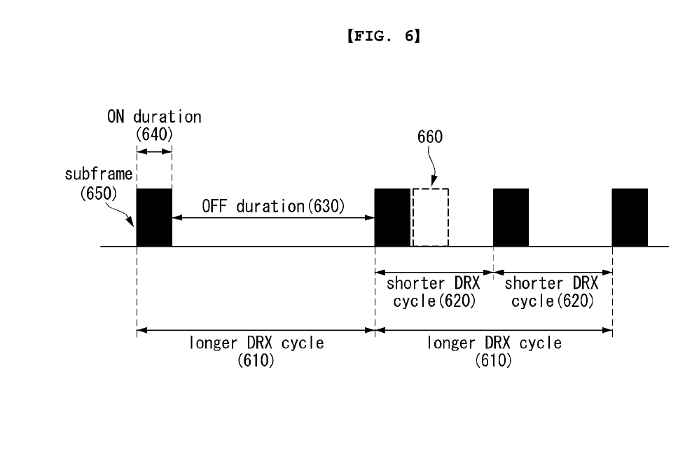

FIG. 6 illustrates an operation of a terminal in a discontinuous reception (DRX) duration to which the present invention is applied.

Referring to FIG. 6, in a communication system to which the present invention is applied, a terminal served by a BS of a serving cell may set a discontinuous reception (DRX) duration in which reception is stopped in a predetermined subframe in order to reduce power consumption of the terminal.

In detail, it may be better for the terminal in terms of data delay to observe downlink control signaling in every subframe, and to immediately react according to change of traffic operation to receive uplink scheduling approval or downlink data transmission.

However, since data transmission does not occur regularly but occur concentratively during a particular period of time. Thus, an operation of a reception circuit in every subframe may increase power consumption of the terminal. In order to reduce such power consumption, the terminal may perform a DRX operation.

Hereinafter, a discontinuous reception will be referred to as DRX. A period from a start point of a DRX ON duration to a point in time immediately before a next ON duration is called a DRX cycle or a DRX period. Namely, the sum of ON duration and the OFF duration of one time corresponds to a DRX cycle.

During the ON duration 640 of the DRX cycle, the terminal may monitor a physical downlink control channel (PDCCH) thereof, monitor a downlink L1/L2 control signal, measure a neighbor cell of the terminal, measure a serving cell, and the like, an may perform at least one of reception of a physical downlink shared channel (PDSCH), reception of uplink timing advance information, reception of a downlink reference signal, or reception of ACK/NACK information regarding uplink data.

When the DRX ON duration 640 terminates, the terminal may return to a sleep state or an idle state according to DRX configuration to turn off the reception function.

Namely, the terminal observes downlink control signaling of only a single subframe 650 in every DRX cycle (640), and turn off a reception circuit in the duration 630 during the other remaining subframes.

TABLE 1

| Index | LCID values |
|---|---|
| 00000 | CCCH |
| 00001-01010 | Identity of the logical channel |
| 01011-11010 | Reserved |
| 11011 | Activation/Deactivation |
| 11100 | UE Contention Resolution Identity |
| 11101 | Timing Advance Command |
| 11110 | DRX Command |
| 11111 | Padding |

Also, during the DRX cycle, when the BS transmits a DRX command MAC control element of Table 1 to the terminal, the terminal may immediately enter the OFF duration 630 even from the ON duration 640.

Through this operation, the terminal may reduce power consumption, and as the DRX cycle lengthens, the terminal may save more power.

If the terminal cannot transmit all the data during the single subframe, an additional subframe is required, and here, waiting for a next DRX cycle may be ineffective in terms of delay. Thus, reception is not turned off until when all the data is received and the terminal may operate even in an additional subframe 660.

The DRX cycle may be divided into a longer DRX cycle 610 and a shorter DRX cycle 620. In general, the DRX cycle may be sufficient only with the longer DRX cycle 610. However, in case of a service having a periodical transmission period or a service featured with very small traffic, the longer DRX cycle 610 is insufficient and the shorter DRX cycle 620 may be selectively used additionally.

In the present invention, by determining whether to measure a neighbor cell depending on a change in a location of the terminal during the ON duration 640 or the OFF duration 630, power consumption of the terminal may be reduced.

Namely, during the ON duration 640, the terminal may determine whether to measure a neighbor cell depending on a change in a location of the terminal, or during the OFF duration 630, the terminal may determine whether to measure a neighbor cell depending on a change in a location thereof.

In this case, the terminal is in the idle mode or sleep mode during the OFF duration 630, the terminal needs to be activated to measure a neighbor cell. In order to be activated from the idle mode or the sleep mode, the terminal should consume a large amount of power, and in particular, in the idle state, the terminal needs to be RRC_Connected state, and thus, power consumption of the terminal is significantly greater than that of the case in the ON duration 640.

Thus, in the idle state, by determining whether to measure a neighbor cell depending on a change in a location of the terminal, power consumption of the terminal can be significantly reduced.

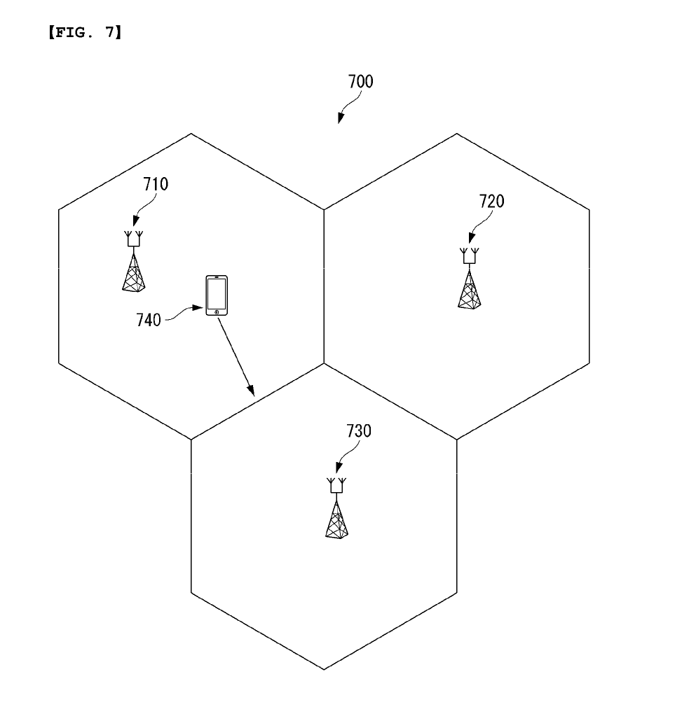

FIG. 7 is an overall schematic view illustrating determining whether to measure a neighbor cell based on a movement of a terminal in a cellular system according to a first embodiment to which the present invention is applied.

Referring to FIG. 7, a process of determining whether to measure a neighbor cell using sensor information, namely, acceleration information, velocity information, location information, and/or direction information of a terminal 740 is illustrated.

Here, it is assumed that, when the terminal 740 does not move, a reception environment of the terminal 740, namely, signal strength of a serving cell 710, is not rapidly changed.

In detail, in a case in which the terminal 740 is served by the serving cell 710 or even in a case in which the terminal 740 is not served, the terminal 740 may periodically measure a neighbor cell. This means that the terminal measures RSRP, RSRQ, RSSI, and the like, of a neighbor cell in order to perform handover to a neighbor cell or perform cell selection or cell reselection.

However, such periodical measurement of a neighbor cell may increase power consumption of the terminal 740. In particular, when the terminal does not move, handover to the neighbor cell 730 or cell reselection does not occur, and thus, periodical measurement of a neighbor cell even in such a case may cause the terminal to unnecessarily consume power.

Thus, by enabling the terminal not to measure a neighbor cell when the terminal does not move, power consumption of the terminal may be reduced.

In another embodiment of the present invention, the terminal may measure a signal transmitted from the serving cell and compare the value with a measurement threshold value. The terminal may determine whether to measure a neighbor cell according to the comparison result, and when the measurement value of a neighbor cell satisfies a measurement report condition, the terminal may report the measurement value of a neighbor cell to the BS of the serving cell.

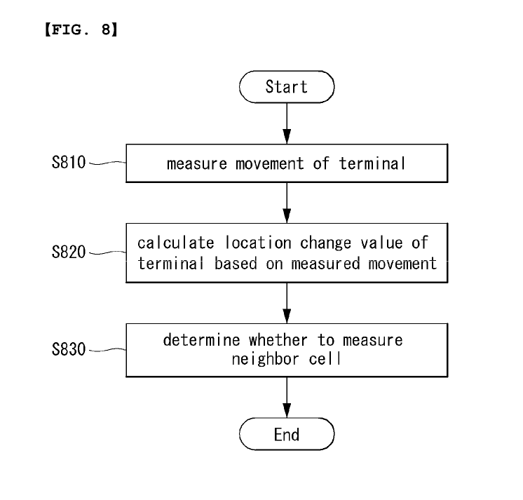

FIG. 8 is a flow chart illustrating determining whether to measure a neighbor cell based on a movement of a terminal according to the first embodiment of the present invention.

Referring to FIG. 8, a movement of a terminal may be measured, and when a location of the terminal has not been changed, measurement of a neighbor cell is not performed, whereby power consumption of the terminal may be reduced.

In detail, the terminal may measure a movement thereof through a sensor thereof (S810). Here, the sensor refers to a sensor that may be able to measure a movement of the terminal, such as an accelerometer, a position sensor, and the like.

The movement may be comprehensive information related to a movement of the terminal including acceleration information, location information, velocity information, angle information, direction information, and the like.

Also, the terminal may obtain information regarding a state of the terminal, for example, GPS information regarding the current location of the terminal, from the outside through a reception unit.

A modem of the terminal may receive measurement movement information from the sensor, and calculate a location change value of the terminal based on the received information. Such a change in a location may indicate that how far the terminal has moved from the current location.

The modem may determine whether to measure a neighbor cell based on the calculate location change (S830). Namely, when there is no change in the location of the terminal, the terminal is highly unlikely to require handover or cell reselection, so it does not measure a neighbor cell, and when a location has been changed, the terminal may move out of the cell region to which the terminal belongs, so a neighbor cell may be measured.

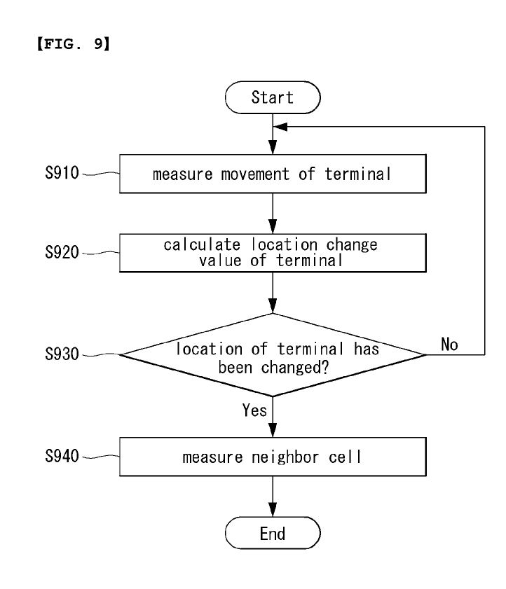

FIG. 9 is a specific flow chart illustrating determining whether to measure a neighbor cell based on a change in a location of a terminal according to the first embodiment of the present invention.

Referring to FIG. 9, the terminal may recognize a change in a location through the sensor. The terminal may determine whether it is moving using the change in the location, and measure a neighbor cell signal. Here, depending on whether the terminal is in an idle state or in a connected state, an operating method and power consumption may differ.

In detail, the terminal may measure a movement of the terminal through the sensor unit (S910) to calculate a location change value (S920). This process is identical to the steps S810 and S820 of FIG. 8. The modem of the terminal may determine whether the terminal is moving or stationary through the calculated location change value (S930).

This is because, when the terminal does not move, the terminal may be continuously stably served by the serving cell or the terminal does not move out of the cell region to which the terminal belongs, eliminating the necessity of handover to a neighbor cell or cell reselection, but in a case in which the terminal is moving, the terminal may move out of the cell region to which the terminal belongs, and thus, handover or cell reselection may be required.

In a case in which the terminal does not move, since handover or cell reselection is not required, and thus, the modem does not measure a neighbor cell. However, when the terminal moves, handover or cell reselection is required, and thus, the modem may measure a neighbor cell (S940).

Here, when the terminal is in an idle mode, the terminal transitions from an inactive state to an active state to measure a neighbor cell and perform a cell reselection or cell selection process.

However, when the terminal is in a connected mode, the terminal is in an active state, and thus, the terminal measures a neighbor cell without transition of a state, and perform a handover process.

In a case in which the terminal is in an idle mode, the terminal needs to transition from an inactive state to an active state to measure a neighbor cell, a large amount of power is consumed, compared with a case in which the terminal is in a connected mode.

This process may be periodically repeatedly performed.

In another embodiment of the present invention, the terminal may obtain information related to a movement of the terminal by the sensor, and calculate a location change value of the terminal based on the obtained information. Here, the information related to the movement may be comprehensive information regarding states of the terminal, including acceleration information, velocity information, location information, direction information, and the like.

The location change value of the terminal refers to a value calculated in consideration of the direction information, the velocity information, the location information, the angle information, and the like, included in the information related to the movement of the terminal.

The calculated location change may be compared with a preset threshold value of the terminal. The threshold value may be a minimum value of a location change that may be calculated when the terminal moves to the neighbor cell, which indicates a value previously set to determine whether to measure the neighbor cell.

The modem control unit of the modem may obtain the result of comparison between the location change value and the threshold value.

When the location change is smaller than the threshold value according to the comparison result, it may be determined that the terminal will not move out of the service region of the serving cell, and the modem control unit may determine not to measure the neighbor cell.

When it is determined not to measure the neighbor cell by the modem, the terminal may switch a measurement gap for measuring the neighbor cell to a power save mode or a sleep mode.

The measurement gap is a duration for measuring the neighbor cell, in which there is no upload and download traffic transmission, and thus, by switching the measurement gap to the power save mode or the sleep mode, power consumption of the terminal may be reduced.

When the location change is greater than the threshold value, the terminal may measure a signal from the neighbor cell through the cell selection measuring unit, and when the measured signal satisfies a measurement report condition, the terminal may report the measurement result to the BS of the serving cell and perform handover to the neighbor cell.

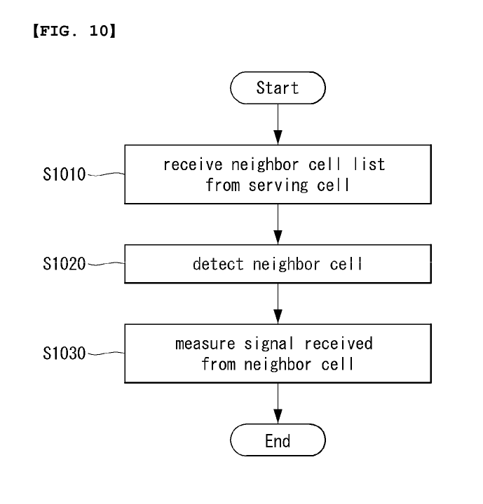

FIG. 10 is a flow chart illustrating a process of measuring a neighbor cell by a terminal according to the first embodiment of the present invention.

Referring to FIG. 10, in a case in which the modem may determine to measure the neighbor cell in FIG. 9, the modem may receive a neighbor cell list from the serving cell, the modem may detect and measure the neighbor cell.

In detail, when the terminal is moving, the terminal may move out of the cell region in which the terminal is located, and thus, handover or cell reselection may be required. Thus, depending on whether the terminal is in an idle mode or a connected mode, the modem may measure the neighbor cell in order to perform handover or cell reselection.

Namely, when measurement of the neighbor cell is required, the modem may receive a list of neighbor cells from the serving cell (S1010). In a case in which the list of neighbor cells is not received from the serving cell, step S1010 may be omitted.

Upon receiving the list of neighbor cells, the modem may detect a neighbor cell available to provide a service around the terminal (S1020). A neighbor cell may be determined according to a movement direction, a velocity, acceleration, or a location.

The modem may measure the neighbor cell using a signal transmitted from the detected neighbor cell, and may measure the neighbor cell based on information included in measurement configuration information received through an RRC message of the serving cell.

The measurement configuration information, as information regarding which cell is to be measured or how a measured cell is to be reported, may include a measurement type, a measurement object, and the like.

In measuring the neighbor cell based on the signal from the neighbor cell, the modem may measure at least any one of RSRP, RSRQ, or RSSI, and report the same to the BS.

The first embodiment may also be applied to a case in which the terminal is in an RRC_Connected Mode, as well as in an RRC_Idle Mode.

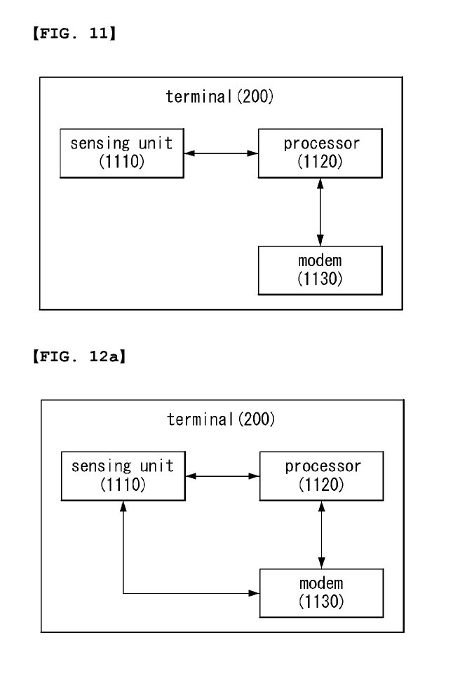

FIG. 11 illustrates a structure in which information of a sensor is transmitted to a modem according to a second embodiment to which the present invention is applied.

Referring to FIG. 11, a sensor 1110 may transmit information related to a measured movement of the terminal to a processor 1120, and the processor 1120 may transmit the same to a modem 1130.

In detail, the modem 1130 may not directly access the sensor 1110 to receive information, so it can receive information from the sensor 110 only through the processor 1120. In this case, the processor 1120 may need to operate in order that the modem 1130 may obtain sensor information, consuming additional power for driving the processor 1120. Thus, a method for solving this problem is proposed as described hereinafter.

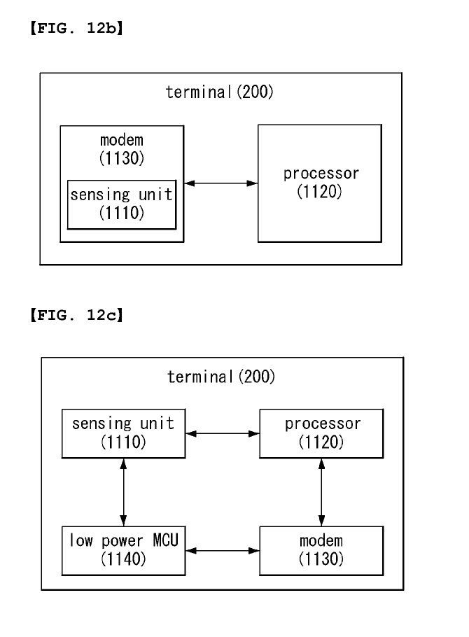

FIG. 12a illustrates a structure in which a sensor and a modem are directly connected according to a third embodiment to which the present invention is applied.

Referring to FIG. 12a, the sensor 1110 and the modem 1130 of the terminal 200 may be directly connected such that the modem 1130 may directly exchange information with the sensor 1110.

In detail, in addition to the individual connection between the sensor 1110 and the processor 1120 and between the modem 1130 and the processor 1120, the sensor 1110 and the modem 1130 may be directly connected and information related to a movement of the terminal 200 measured by the sensor 1110 may be directly transmitted to the modem 1130.

Accordingly, since the sensor 1110 does not need to go through the processor 1120 in order to transmit measured information related to a movement of the terminal to the modem 1130, the processor 1120 may not need to be operated separately.

FIG. 12b illustrates a structure in which a sensor is included in a modem according to a third embodiment to which the present invention is applied.

Referring to FIG. 12b, since the sensor 1110 is included in the modem 1130, the modem 1130 does not need to go through the processor 1120 in order to obtain a location change value of the terminal 200.

In detail, since the sensor 1110 is included in the modem 1130, the modem 1130 may directly measure information related to a movement of the terminal 200 through the sensor 1110 and calculate a change in a location using the same.

FIG. 12c illustrates a structure in which a sensor and a modem are connected by a low power micro-control unit (MCU) according to a third embodiment to which the present invention is applied.

Referring to FIG. 12c, the sensor 1110 may transmit measured information related a movement of the terminal 200 to a low power MCU 1140, and the low power MCU 1140 may transmit the received information to the modem 1130.

In detail, the sensor 1110 may transmit measured information related to a movement of the terminal 200 to the low power MCU 1140 which consumes a small amount of power, rather than to the processor 1120. Upon receiving the information related to a movement of the terminal 200, the low power MCU 1140 may transmit the received information to the modem 1130.

Accordingly, the sensor 1110 may transmit the information to the modem 1130 through the low power MCU 1140 that consumes a small amount of power, relative to the processor 1120, without going through the processor 1120.

As described above with reference to FIGS. 12A through 12C, the sensor 1110 may transmit information related to a movement of the terminal 200 to the modem 1130 without going through the processor 1120.

Thus, additional power consumption for driving the processor 1120 does not occur, and thus, power consumption of the terminal 200 may be reduced.

The foregoing embodiments and advantages are merely exemplary and are not to be considered as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds are therefore intended to be embraced by the appended claims.

What is claimed is:

1. A method for reducing power consumption of a terminal in wireless communication system, the method comprising:
measuring movement information of the terminal;
calculating a location change value of the terminal based on the movement information;
determining whether there is movement of the terminal based on the location change value; and
determining whether to measure a neighbor cell in power saving duration of discontinuous reception duration based on the determination of whether there is movement of the terminal,
wherein the power saving duration is duration that the terminal does not transceive data, and
wherein the movement information includes at least one of velocity information, acceleration information, location information, direction information or angle information of the terminal.

2. The method of claim 1,
wherein the step of determining whether to measure of the neighbor cell is characterized that the terminal does not measure the neighbor cell when it is determined that there is no movement of the terminal.

3. The method of claim 1, wherein the step of determining measurement of a neighbor further comprises,
measuring the neighbor cell, when it is determined that there is movement of the terminal.

4. The method of claim 3, the method further comprises:
changing a state of the terminal to RRC (Radio Resource Control) connection state; and
receiving a message including neighbor cell list information,
wherein the step of measuring the neighbor cell is further comprises,
detecting the neighbor cell using the neighbor cell list information,
receiving a control signal from the detected neighbor cell, and
measuring the neighbor cell based on the received control signal.

5. A terminal comprises:
a sensing unit configured to measure movement information of the terminal;
a modem configured to calculate a location change value of the terminal based on the movement information, to determine whether there is movement of the terminal based on the location change value, and to determine whether to measure a neighbor cell in power saving duration of discontinuous reception duration based on the determination of whether there is movement of the terminal; and
a processor configured to receive information related to movement of the terminal and to provide the information to the modem,
wherein the power saving duration is duration that the terminal does not transceive data, and
wherein the movement information includes at least one of velocity information, acceleration information, location information, direction information or angle information of the terminal.

6. The terminal of claim 5,
wherein the modem does not measure the neighbor cell, when it is determined that there is no movement of the terminal.

7. The terminal of claim 5,
wherein the modem measures the neighbor cell, when it is determined that there is movement of the terminal.

8. The terminal of claim 7, wherein the modem is further comprises,
a communication unit configured to receive a message including a neighbor cell list, and a control signal from a detected neighbor cell,
a cell detecting unit configured to detect the neighbor cell using the neighbor cell list, and
a cell measurement unit configured to measure the neighbor cell based on the control signal.

9. The terminal of claim 5,
wherein the sensing unit configured to transmit information related to moving of the terminal.

10. The terminal of claim 5,
wherein the sensing unit is included in the modem.

11. A terminal comprises:
a sensing unit configured to measure movement information of the terminal;
a modem configured to calculate a location change value of the terminal based on the movement information, to determine whether there is movement of the terminal based on the location change value, and to determine whether to measure a neighbor cell in power saving duration of discontinuous reception duration based on the determination of whether there is movement of the terminal; and
a MCU (Micro Control Unit) configured to receive the movement information, and to deliver the movement information to the modem,
wherein the power saving duration is duration that the terminal dose not transceive data, and
wherein the movement information includes in at least one of velocity information, acceleration information, location information, direction information or angle information of the terminal.
